(19) United States
(12) Patent Application Publication
(10) Pub. No.: US 2026/0126544 A1
(43) Pub. Date: May 7, 2026

(54) Operation method of a target detection radar and associated detection radar

(71) Applicant: THALES, Meudon (FR)

(72) Inventors: Philippe GOY, MERIGNAC (FR); Rodolphe COTTRON, MERIGNAC (FR); Yoan VEYRAC, MERIGNAC (FR)

(21) Appl. No.: 19/380,119

(22) Filed: Nov. 5, 2025

(30) Foreign Application Priority Data
Nov. 7, 2024 (FR) 2412182

(51) Int. Cl. G01S 13/72; G01S 7/35

(52) U.S. Cl. CPC G01S 13/726; G01S 7/354

(57) ABSTRACT

A method of operation for a target detection radar, including determining a plurality of active tracks in a visibility cone, each active track showing a target to pursue, for each active track, determining a waveform allowing its detection and tracking, determining compatibility of active tracks by comparing the determined waveforms for these tracks to form at least one set of compatible active tracks, and for the or each set of compatible active tracks, emitting/receiving a communal wave including consecutive pulses, each pulse being associated with one of the active tracks of the set.

### REFERENCE TO RELATED APPLICATIONS

This application is a U.S. non-provisional application claiming the benefit of French Patent Application No. 24 12182 filed on Nov. 7, 2024, the contents of which are incorporated herein by reference in their entirety.

### TECHNICAL FIELD OF THE INVENTION

The present invention relates to a method of operation for a target detection radar.

The invention also relates to a detection radar implementing such a method.

The technical field of the invention is that of radar systems embedded on aircraft, ships, submarines or satellites, for example, implementing target detection/identification.

The general problem solved by the invention is the time budget management in view of the growing demand for new detection and identification functionalities required by radar systems.

### BACKGROUND OF THE INVENTION

Traditionally, a radar system can be used in a “single-task” manner, meaning a single “mode” of operation throughout the mission, such as when using a maritime surveillance mode adapted to a given altitude and type of target.

In particular, in a “single-task” mode, the radar uses a space scanning logic that does not vary over time, as long as the operator does not change the mission or mode. The time budget is then associated only with this task.

For many years, radar operators have sought to expand the employment spectrum of radar detection systems, seeking for them to become “multi-tasking.” For example, simultaneously having a maritime/aerial tactical situation and possibly having feedback on weather conditions. The system must then define the time budget to allocate to each task to be performed.

Obviously, the more time allocated to a task, the more effective it will be (better detection or discrimination capability, for example). Therefore, the management and optimization of the time budget appear crucial for new radar systems.

Traditionally, the radar employs “short time” (at the processing block scale) or “long time” (at the scanning scale) interleaving strategies to carry out its different tasks. A time budget is allocated to each of these tasks based on a compromise of the performance of each function taken individually (refresh time, detection range, etc.)

The interleaving of radar blocks is then a technique that temporally schedules tasks that are not simultaneous.

To obtain simultaneous tasks, the way of proceeding known by those skilled in the art is to break down the radar antenna system into several sub-networks and allocate a task to each sub-network, to perform what is called colored emission. This operation is mainly found in MIMO-type radar systems (from the English “Multiple Input Multiple Output”). The simultaneous emission of several orthogonal waveforms is thus made to color the space, that is, to associate a pair {sub-network, waveform} with a direction {azimuth-elevation}. The colored emission enables either obtaining a complete vision of the environment by drastically increasing the refresh time of a task or performing several tasks simultaneously.

However, this break down of the antenna space into sub-networks and the colored emission are not necessarily available or desirable in terms of the balance of a given radar architecture.

Active tracking is a radar function that ensures optimal visibility and detectability of a tracked target by using dedicated illuminations in the direction of the target, with one or more waveforms calculated to optimize visibility in the area (distance, speed) where the track is located. In active tracking, an evaluation of an estimated equivalent radar surface (also called SER, from the English, “Surface Equivalent Radar”) and the distance of the target is available.

In general, active tracking Doppler waveforms are designed by choosing the repetition frequencies Fr, the associated wavelengths λ, and the number of recurrences per Fr to minimize the associated time budget while maintaining a very comfortable Signal-to-Noise Ratio (SNR) to detect the target. Such an algorithm named {λ, Fr} is known to those skilled in the art.

A radar scheduler then integrates the active tracking tasks concerning the relative priorities vis-à-vis surveillance pointing and maintenance tasks.

A fixed or dynamic time budget is allocated to the active tracking tasks, in practice limiting either the number of active tracks or the surveillance capacity to be maintained, depending on the compromise sought: imperative maintenance of surveillance at the expense of active tracking or imperative maintenance of active tracking at the expense of surveillance. The optimization of the time budget allocated to active tracking thus presents a significant problem in radar budget management.

### SUMMARY OF THE INVENTION

The present invention aims to address this problem and therefore to propose the means to optimize the time budget allocated to active tracking.

To this end, the invention aims at a method of operation of a target detection radar, the detection radar implementing a scanning forming a visibility cone;
the method including the following operations:
determination in the visibility cone of a plurality of active tracks, each active track showing a target to pursue;
for each active track, determination of a waveform allowing its detection and tracking;
determination of compatibility of active tracks by comparing the determined waveforms for these tracks to form at least one set of compatible active tracks;
for the or each set of compatible active tracks, emission/reception of a communal wave including consecutive pulses, each pulse being associated with one of the active tracks of the set.

According to other advantageous aspects of the invention, the method includes one or more of the following features, taken individually or according to all technically possible combinations:
the method further including emission/reception of a simple wave including a single pulse for each active track not belonging to any set of compatible active tracks;
each waveform defines a field of visibility of a wave having this form;
each field of visibility includes a field in distance and a field in speed of an active track;
two active tracks are compatible when they are in the same field of visibility with a probability greater than a predetermined threshold;
each waveform is defined by a wavelength, a respective emission frequency and a repetition frequency of a wave having this form;
the compatibility of active tracks is verified by testing different wavelength values and/or repetition frequency;
the compatibility of active tracks is determined for each pair of active tracks;
the pulses of the same communal wave are associated with different emission directions;
each n^{th} recurrence of the emission/reception operation of the communal waves includes the following sub-operations:
   generation of at least two consecutive pulses associated with different active tracks of the same set of compatible active tracks;
   emission of the pulses in different frequency bands;
   reception of the echoes of the pulses in a common time window;
each pulse is emitted with a random phase associated with the corresponding frequency band;
the reception sub-operation includes the compensation of the dephasing of the echoes received in each frequency band by the random phase associated with this frequency band;
during the emission sub-operation, the corresponding pulses are emitted using different slopes of chirps used to emit them;
during the reception sub-operation, echoes associated with different active tracking pointing are distinguished by determining the slopes of the corresponding chirps;
during the emission sub-operation, the corresponding pulses are emitted using different polarizations;
during the reception sub-operation, echoes associated with different active tracking pointing are distinguished by determining their polarizations;
a polarization is emitted for each pulse, or a set of polarizations forming a signature is emitted for each pulse.

The invention also aims at a target detection radar including technical means configured to implement the method as defined above.

### BRIEF DESCRIPTION OF THE DRAWINGS

The invention will appear more clearly upon reading the following description, given solely by way of non-limiting example, and made with reference to the drawings, wherein:

FIG. 1 is a schematic view of a detection radar according to the invention;

FIG. 2 is a flowchart of a method of operation of the radar of FIG. 1;

FIGS. 3-5 are different views illustrating the implementation of the method of FIG. 2.

### DETAILED DESCRIPTION OF THE INVENTION

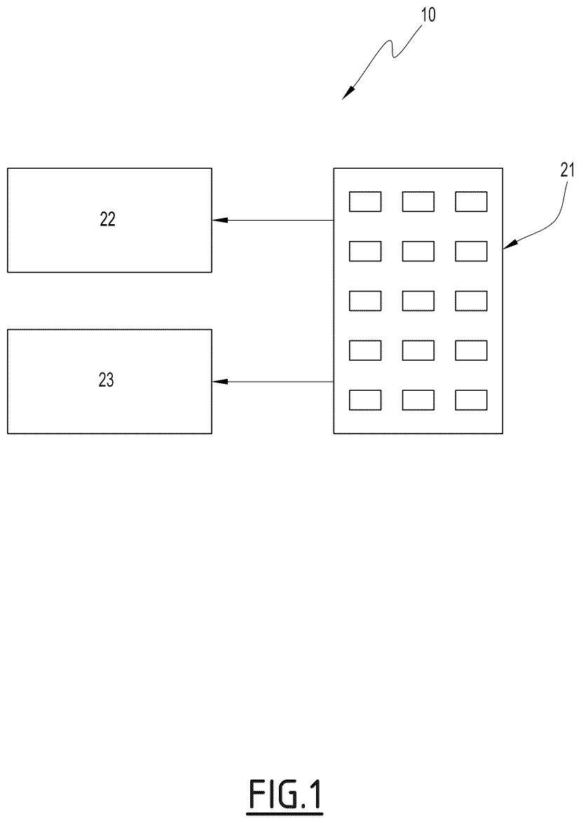

FIG. 1 illustrates a detection radar 10 according to the invention. This radar 10 is intended to be embedded on a mobile carrier moving in the air and/or on a terrestrial surface and/or on a maritime surface, for example. Advantageously, the radar 10 is intended to be embedded on a carrier moving in the air, such as an aircraft. Alternatively, the radar 10 is arranged in a fixed manner.

The radar 10 enables detecting targets according to one or more surveillance modes. “Surveillance mode” is understood as an observation mode that consists of regular pointing. An example of such a mode is a Doppler mode of the MMTI type (from the English “Maritime Moving Target Indicator”), GMTI (from the English “Ground Moving Target Indicator”), AMTI (from the English “Aerial Moving Target Indicator”), etc.

With reference to FIG. 1, the radar 10 includes an array of elementary antennas 21, allowing the emission of signals in the form of pulses and the reception of signals corresponding to echoes of these pulses.

The radar 10 further includes an emission unit 22, allowing the generation of the pulses to be emitted by the antenna array 21 and a reception unit 23, allowing the processing of the echoes received by the antenna array 21 to deduce the presence of a target and, possibly, a speed and a distance to this target.

Each of the units 22, 23 is made in the form of a programmable circuit of the FPGA type (from the English “Field Programmable Gate Array”) and/or of the ASIC type (from the English “Application-Specific Integrated Circuit”), for example. In addition, or in a variant, each of these units 22, 23 is made at least partially in the form of software executable by a processor and stored in a memory.

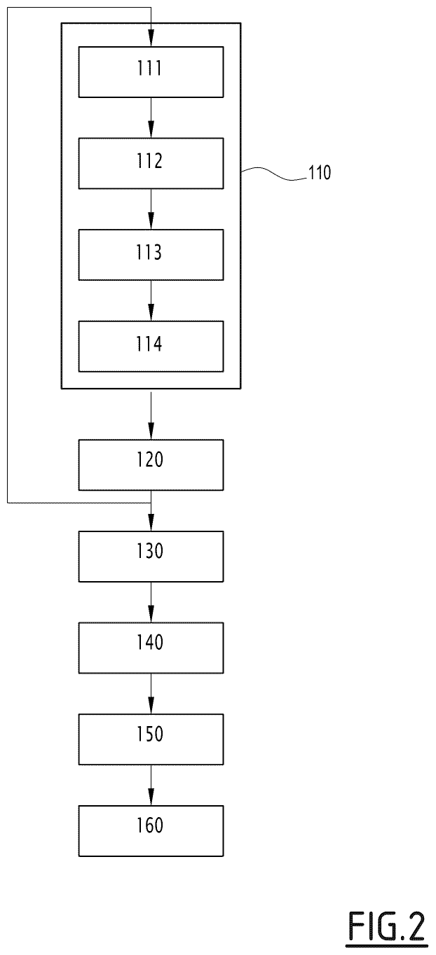

The method of operation of the radar 10 will now be explained with reference to FIG. 2 showing a flowchart of its operations.

This method is considered implemented during an electronic scanning of the space around the radar 10. In particular, this method includes the iterative implementation of at least operations 110 and 120 described below for each pointing position of the radar 10. Each iteration of these operations is called a recurrence.

It is further considered that the pointing positions succeed each other according to a predetermined rotation direction and all define an angular opening dependent on the pointing angle, known to those skilled in the art. The set of pointing positions defines an available visibility cone of the radar 10. In other words, “visibility cone” is understood as the set of different pointing positions during a scanning round performed by the radar 10.

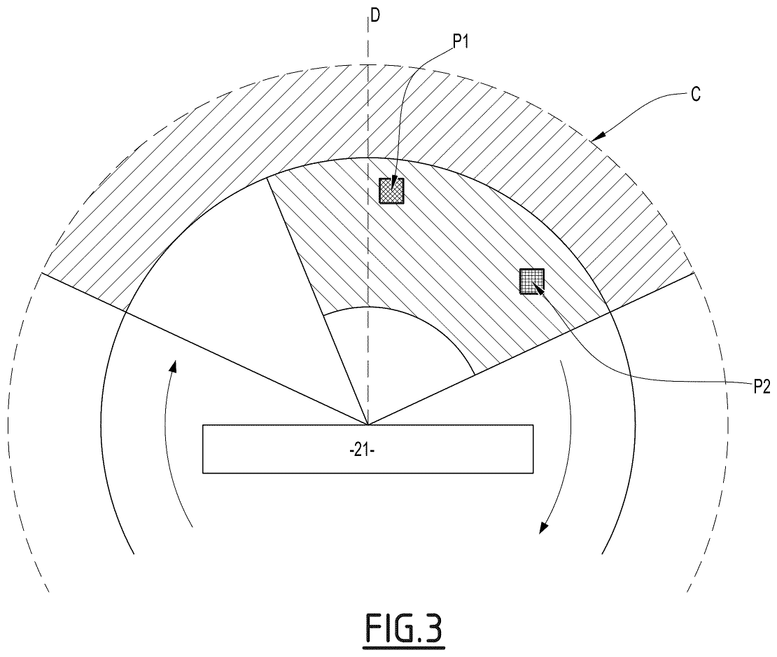

FIG. 3 illustrates such a visibility cone C. In the example of this figure, the visibility cone C is formed by the angles +65° and −65° relative to the normal direction D to the antenna array 21. Thus, this visibility cone C forms an opening angle of 130°. To cover a larger opening angle such as an opening angle of 360° (that is, to form a complete turn in space), an antenna panel receiving the antenna array 21 may be mounted on a mechanical pedestal.

The mechanical rotation of the pedestal enables continuously modifying the position of the panel's visibility cone. This mechanical rotation allows the antenna to cover an angular field of 360°, for example. In this architecture, electronic scanning in azimuth enables radar pointing “ahead” or “behind” relative to the normal antenna, to accommodate the radar tasks sequenced by the scheduler.

A second solution to cover 360° of visibility with a single panel is to replace the pedestal with a positioner. The latter positions the normal antenna on a few angular values, such as 90°+, −90° and 180°, so that the electronic scanning of the panel is sufficient to cover all positions.

Once positioned, the antenna array 21 thus electronically scans its visibility cone, then the positioner locks onto a new position (emission stop) and the electronic scanning resumes until all positions are covered.

A final solution consists of structuring as many fixed antenna panels as possible so that the sum of their visibility cones allows a 360° area to be covered.

The method described below is adaptable to each of the architectures mentioned.

Inside, the visibility cone defines a plurality of visibility fields successively traversed during the radar 10 scanning.

Each visibility field corresponds to a geographical area wherein a target with a certain speed is detectable by a wave sent from the radar 10. Thus, each visibility field is determined by a waveform sent from the radar 10. In addition, each visibility field is defined by a field in distance measured from the radar 10 and a field in speed of the target.

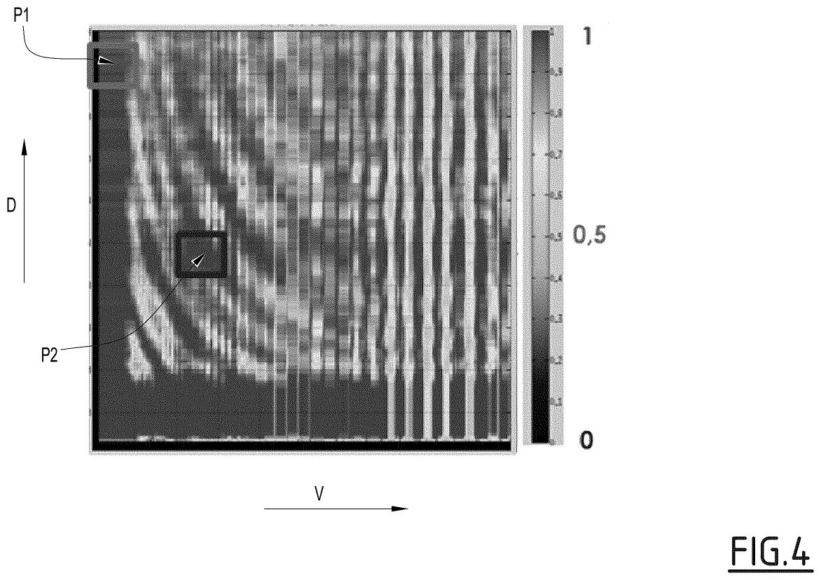

In other words, as illustrated in FIG. 4, each visibility field may be defined by a probability that a target located at a particular distance from the radar 10 and having a particular speed is detected by a Doppler waveform sent from the radar 10. The probability thus varies from 0 to 1.

Each waveform is defined by a wavelength λ and a repetition frequency Fr of a wave having this form. In other words, each waveform is defined by a pair of values {λ, Fr}.

In reference to FIG. 1, each n^{th} recurrence of operation 110 includes an emission/reception of signals in the corresponding pointing position.

In particular, during this operation, the emission unit 22 of the radar 10 emits signals having a particular waveform and the reception unit 23 receives echoes of these signals.

This operation 110 of signal emission/reception includes several sub-operations whose implementation depends on the type of signals chosen. These sub-operations will be explained in detail later. This operation 110 also includes filtering and detection processing, as will be explained later.

During each n^{th} recurrence of the following operation 120, the radar 10 and specifically its reception unit 23 implement an analysis of the received signals. In particular, this operation 120 includes a “turn-by-turn” extraction processing, for example, or any other processing allowing target identification in a surveillance mode.

A target is considered detected when, at the end of this processing, the radar 10 concludes that such a target is present in the considered area.

A target is considered definitively detected when, after several implementations of operations 110 and 120, at least K detections are present and correlate in the same area over a horizon of N implementations of these operations. In this notation, the number K means the number of operations 120 during which the target was considered detected. The coefficient K/N may then be compared with a threshold, called the target extraction threshold.

During the following operation 130, implemented after several recurrences of operations 110 and 120, a request for tracking one or more targets considered definitively detected during operation 120 is acquired, by the reception unit 23 of the radar 10, for example.

Such a request may come from a user, for example, or an external system connected to the radar 10.

The or each target for which such a request has been received is considered an active track, and active tracking is thus implemented for this target. This active tracking includes an emission/reception of signals of a particular waveform towards each active track during operation 110, as will be explained later. In particular, unlike a surveillance mode, an active tracking consists of irregular pointing. The active tracking includes completing the surveillance grid with pointing associated with specific waveforms, calculated on the fly. This pointing is dedicated to detecting the tracked target, unlike surveillance pointing seeking to detect the maximum number of potential targets.

During the following operation 140, the emission unit 22 determines a plurality of active tracks in the instantaneous visibility cone, that is, in the visibility cone defined by the antenna array 21 without taking into account any mechanical scanning.

This plurality of active tracks corresponds to the set of targets for which a tracking request was received during the previous operation, for example.

During the following operation 150, the emission unit 22 determines a waveform for each active track. As previously indicated, such a waveform is defined by a pair {λ, Fr}.

To do this, a {λ, Fr} type algorithm, known per se, may be implemented. Such an algorithm also enables maintaining a necessary Signal-to-Noise Ratio (SNR) to detect a plot and feed the active track of interest while minimizing the illumination time necessary for this detection. For this, the {λ, Fr} type algorithm also determines a number of recurrences Nrec compatible with the detection for each active track.

During the following operation 160, the emission unit 22 determines the compatibility of the active tracks identified during the previous operation.

Active tracks are said to be compatible when there is the same waveform, then called a compatible waveform, that may be used for the tracking of each of these active tracks. In other words, active tracks are compatible when they are in the same field of visibility defined by the corresponding compatible waveform, with a probability greater than a predetermined threshold. This threshold may be close to 1, for example. It may be approximately equal to 0.90 or 0.95, for example.

FIG. 4 illustrates a case when two active tracks, namely active tracks P1 and P2, are in the same field of visibility with a probability close to 1. These active tracks thus form a set of compatible tracks.

To implement this operation, according to an exemplary embodiment, the emission unit 22 implements a compatibility test for each pair of compatible active tracks determined during the previous operation. For example, when M active tracks have been determined during the previous operation, the emission unit 22 performs at most M×(M−1) compatibility tests.

Each compatibility test then includes a comparison of two pairs {λ, Fr} defining the determined waveforms for the corresponding active tracks, to determine, if possible, a pair {λ, Fr} compatible with the first two pairs. This last pair {λ, Fr} defines a compatible waveform for the two active tracks, which may then be considered compatible. This compatible waveform may eventually reduce the initial SNR in relation to each track. This SNR remains acceptable to pursue the corresponding active tracks, however.

When a compatible waveform has been determined by the test, the corresponding active tracks are thus compatible. Otherwise, these tracks are incompatible.

According to an exemplary embodiment, the compatibility test is performed on each Fr value previously chosen by crossing the λ values defined for each track and testing the positions {distance, speed} (that is, the field of visibility) of each track. A compatibility matrix is then defined to determine which tracks and which pairs {λ, Fr} (or triplets {λ, Fr, Nrec}) are associable or not.

In particular, before implementing such a compatibility test, it is considered that the triplets {λ, Fr, Nrec} are calculated for each track. Then, the λ values are crossed by taking the triplet {λ1, Fr2, Nrec2} for a first track and the triplet {λ2, Fr1, Nrec1} for a second track. The triplet {λ2, Fr1, Nrec1} is compatible with the detection of the second track if:
the probability of visibility of the second track is satisfactory with the Fr1 value;
the SNR required for the detection of the second track is satisfactory with the Nrec1 value.

Then, the compatibility of the triplet {λ1, Fr2, Nrec2} with the detection of the first track is analyzed in the same way.

The compatibility matrix may aggregate two or three notes.

When the compatibility matrix aggregates two notes, the first note is the compatibility of the two λ values with each other. In particular, to implement the technique of emitting a communal wave as will be described below, the λ values must be sufficiently spaced to accommodate the emitted bands and sufficiently close to remain in the instantaneous band of the radar 10.

The second note is the visibility note of active track number n with its own λ value and the Fr value corresponding to that of active track number k.

When the compatibility matrix aggregates three notes, the third note signifies compatibility in terms of detection balance (SNR).

The search for λ is imposed, whether one operates at a constant ambiguous speed waveform (V_{amb}=λ×Fr/2) or at a constant ambiguous distance (D_{amb}=c×Tr/2).

The search principle works in both cases.

In an example embodiment, the search is performed by testing only the λ values already associated with the tracks. Conversely, it is possible to perform a more complex and costly search around the λ compatible with target number n to apply to target number k.

At the end of this operation 160, at least one set of compatible tracks is formed. This set is constituted of a pair of compatible active tracks, for example. At the end of this operation, K active tracks are considered compatible and K/2 pairs of compatible tracks are formed, for example.

The other active tracks (that is, M-K active tracks) are then considered incompatible.

The compatibility/incompatibility of each active track defines the way of implementing the emission/reception operation 110 of the signals towards this track during the next occurrences of operations 110 and 120.

In particular, for each incompatible active track, this operation 110 includes a sub-operation 111 of generating a pulse, an operation 112 of emitting this pulse in a frequency band corresponding to the waveform determined for this active track, an operation 113 of receiving an echo of this pulse in a predetermined duration time window, and a sub-operation 114 of pre-processing the received echoes including, an adapted filtering and an adapted detection processing (such as in power or contrast), for example.

In other words, for each incompatible active track, this operation 110 includes an emission/reception of a simple wave according to techniques known in themselves.

On the contrary, for each set of compatible active tracks, this operation 110 includes an emission/reception of the same communal wave.

Each communal wave includes at least two consecutive pulses associated with compatible active tracks belonging to the same set. For example, each pulse is associated with an emission direction corresponding to the active track associated with this pulse.

In such a case, during sub-operation 111, the emission unit 22 of the radar 10 generates consecutive pulses associated with compatible active tracks. For example, during this sub-operation, at least two pulses are generated. In particular, the number of pulses corresponds to the number of corresponding compatible active tracks.

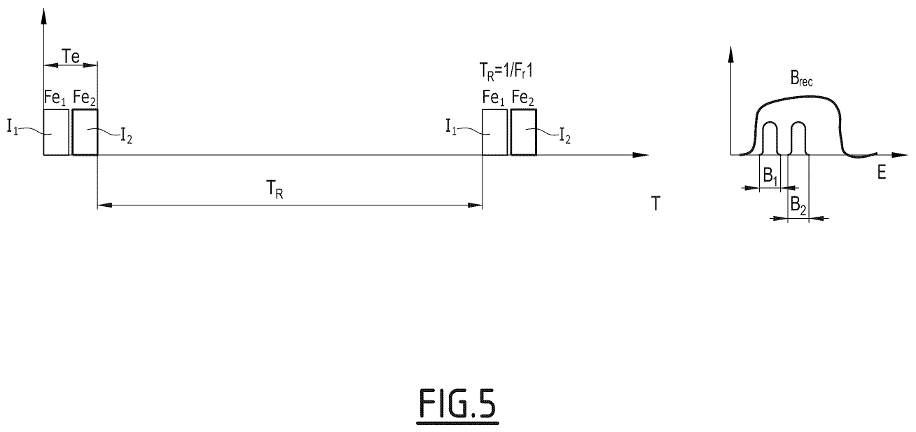

According to this example, the emission unit 22 generates a first pulse I₁ and a second pulse I₂, illustrated in FIG. 5.

Each pulse is associated with a particular emission direction, for example. This emission direction may be defined by a pair of angular values, for example. These angular values correspond to the elevation (or site) and azimuth of emission, for example, denoted hereafter by Elᵢ and Azᵢ, respectively. In all that follows, the index i=1 designates any value relative to the first pulse, and i=2 designates any value relative to the second pulse.

The pulses are generated in an emission window Te wherein each pulse has a width Li and is spaced from the other pulse and one of the boundaries of the emission window Te by a time gap T_{GAP}. The widths of the pulse Li are advantageously chosen as identical, to obtain the same pulse compression processing for the two targets and the same processing gain.

In the frequency field, the pulses share the same frequency support B_{rec}, with a frequency gap F_{GAP} between the corresponding carriers Fi greater than the frequency bands Bi of these pulses. This frequency support is defined by the compatible waveform corresponding to the compatible active tracks. The frequency gap F_{GAP} is chosen sufficient to distinguish the echoes of these pulses upon reception. In all that follows, a frequency band is defined by a central frequency and a bandwidth. Advantageously, in the following, all frequency bands have the same width. In addition, the frequency gap F_{GAP} is measured between a pair of corresponding central frequencies and is greater than the width of each frequency band.

The frequency bands B₁ and B₂ of the respective first pulse I₁ and the second pulse I₂ are advantageously chosen the same for each recurrence of operation 110. Thus, the same central frequency Fe₁ and the same central frequency Fe₂ are chosen for the respective first pulse and second pulse in each recurrence of operation 110.

These values Fe₁ and Fe₂ correspond to the λ values chosen for the respective compatible active tracks. In particular, λᵢ=c/Feᵢ with c the speed of light. Thus, the associated emission frequencies Fe₁ and Fe₂ are chosen sufficiently close to fit into the reception band of the radar 10 and sufficiently far apart to contain the emitted bands related to each pulse, without overlap.

During the sub-operation 112, the emission unit 22 emits the pulses generated during the previous sub-operation in the corresponding frequency bands.

During the sub-operation 113, the reception unit 23 receives echoes corresponding to the emitted pulses in a common reception time window. The duration Tr of this common reception window is equal to the total duration of the recurrence T_{R} (that is, the observation time of the corresponding pointing for a recurrence) minus the duration of the emission window Te. During reception, the echoes corresponding to different pulses are distinguished by the different frequency bands, using adapted band-pass filters, for example. A spatial filtering of the FFC type may also be applied in the direction associated with the band.

During the sub-operation 114, the reception unit 23 performs a pre-processing of the received echoes including an adapted filtering and an adapted detection processing (such as in power or contrast), for example.

The results of such pre-processing are used as inputs for operation 120.

It is then understood that the method according to the invention presents a number of advantages.

In particular, according to the method of the invention, the emission of communal wave-type signals for at least two active tracks is particularly advantageous because it saves the time budget when the radar is used in active tracking.

Despite a loss in the energy balance related to cutting the emission window into sub-pulses, this technique remains particularly advantageous compared to MIMO and colored emission techniques, enabling keeping the complete balance of the antenna (emitted power and emission/reception gains).

In some embodiments, the method of operation as explained above further includes the implementation of at least one technique allowing better separation of the pulse echoes corresponding to different active tracking pointing, during the emission/reception of communal waves, and/or rejecting consideration of certain echoes that are not necessary or are ambiguous in distance.

According to a first technique, during the implementation of the n^{th} recurrence of operation 110 and specifically during the emission sub-operation 112, the emission unit 22 chooses one of the pulses, such as the first pulse, and adds a random phase to this pulse. Advantageously, the emission unit 22 adds a different random phase φ_{¿} to each of the pulses. The or each pulse having a random phase φ_{¿} added is hereafter called a de-phased pulse.

It should be noted that the choice of the pulse to de-phase may remain the same for each recurrence of this sub-operation 112. In other words, when only one pulse is de-phased during this sub-operation, the same pulse is de-phased in each recurrence of this operation. When both pulses are de-phased during this sub-operation, these pulses are also de-phased in each recurrence of this sub-operation.

Then, during the reception sub-operation 113, the reception unit 23 compensates for the phase shift of the echoes received in the frequency band of the or each de-phased pulse, by the corresponding random phase. In other words, the dephasing is performed by subtracting the value φ_{¿} in the band corresponding to the index i. This dephasing corresponds to the known distance ambiguity rank of the active track. Advantageously, the random phase compensation processing associated with the Doppler processing is the adapted filtering for all echoes from the same ambiguity rank as the active track. This enables advantageously isolating other target echoes, or even rejecting part of the ground or sea clutter.

Thus, during the subsequent processing, only the echoes corresponding to the ambiguity rank of the sought active track are processed coherently. The dephasing of other echoes cannot be done correctly, so they are considered to behave like white noise.

Other techniques to obtain better isolation of echoes corresponding to different active tracking pointing during their reception are also possible.

Thus, according to a second usable technique, during the implementation of the nth recurrence of operation 110 and specifically during the emission sub-operation 112, the emission unit 22 implements different slopes of chirps used to emit the pulses associated with different active tracking pointing. In other words, during this sub-operation 112, the emission unit 22 emits the pulses using either an ascending slope or a descending slope, depending on the active track associated with each pulse. The same slope is then used for all pulses of this type in all recurrences of operation 110.

For example, for all recurrences, an ascending slope is chosen for pulses associated with a particular active track, and a descending slope is chosen for pulses associated with another active track.

Then, during the reception sub-operation 113, the reception unit 23 receives echoes having different frequency slopes. This reception unit 23 thus determines the received slopes (using specifically adapted filters) to isolate the echoes corresponding to different active tracking pointing.

According to a third usable technique and also allowing better isolation of echoes corresponding to different active tracking pointing during their reception, during the implementation of the n^{th} recurrence of operation 110 and specifically during the emission sub-operation 112, the emission unit 22 implements different polarizations of the waves used to emit the pulses associated with different active tracking pointing. In other words, during this sub-operation 112, the emission unit 22 emits the wave carrying each pulse with a polarization chosen depending on the active track associated with this pulse. This same polarization is chosen for this type of pulse for all recurrences of operation 110.

For example, two polarizations, namely a vertical polarization and a horizontal polarization, may be chosen for the pulses emitted during the emission sub-operation 112. According to other examples, a 45° or circular polarization may be used.

Then, during the reception sub-operation 113, the reception unit 23 receives echoes having different polarizations. This reception unit 23 thus determines the polarizations of the received echoes (using specifically adapted filters) to isolate the echoes corresponding to different active tracking pointing.

The principle just described may be refined by using several polarizations in the same pulse.

In such a case, each pulse includes a specific polarization signature. Such a signature corresponds to a polarization code.

This technique thus enables coloring the different pulses in space and obtaining an additional rejection of 20 to 30 dB.

In some embodiments, the aforementioned techniques are combined to be implemented simultaneously.

1. A method of operating a target detection radar, the detection radar implementing a scanning forming a visibility cone, the method comprising:
determining a plurality of active tracks in the visibility cone, each active track showing a target to pursue;
for each active track, determining a waveform allowing its detection and tracking;
determining compatibility of active tracks comprising comparing the determined waveforms for these tracks to form at least one set of compatible active tracks; and
for each set of compatible active tracks, emitting/receiving a communal wave comprising consecutive pulses, each pulse being associated with one of the active tracks of the set, wherein each n^{th} recurrence of the emitting/receiving comprises:
generating at least two consecutive pulses associated with different active tracks of the same set of compatible active tracks;
emitting the pulses in different frequency bands; and
receiving echoes of the pulses in a common time window.

2. The method according to claim 1, wherein active tracks are compatible when there is a same waveform usable for tracking each of the active tracks.

3. The method according to claim 2, further comprising emitting/receiving a simple wave comprising a single pulse for each active track not belonging to any set of compatible active tracks.

4. The method according to claim 2, wherein each waveform is defined by a wavelength, a respective emission frequency and a repetition frequency of a wave having this form.

5. The method according to claim 4, wherein said determining compatibility comprises testing different values of wavelength and/or repetition frequency.

6. The method according to claim 2, wherein said determining compatibility is determined for each pair of active tracks.

7. The method according to claim 2, wherein the pulses of the same communal wave are associated with different emission directions.

8. The method according to claim 2, wherein each pulse is emitted with a random phase associated with the corresponding frequency band, and wherein said receiving echoes comprises compensating dephasing of the echoes received in each frequency band, by the random phase associated with this frequency band.

9. The method according to claim 2, wherein said emitting pulses comprises emitting the corresponding pulses using different slopes of chirps to emit them, and wherein said receiving echoes comprises distinguishing echoes associated with different active tracking pointing by determining the slopes of the corresponding chirps.

10. The method according to claim 2, wherein said emitting pulses comprises emitting the corresponding pulses using different polarizations, and wherein said receiving echoes comprises distinguishing echoes associated with different active tracking pointing by determining their polarizations.

11. The method according to claim 10, further comprising emitting a polarization for each pulse, or emitting a set of polarizations forming a signature for each pulse.

12. The method according to claim 1, wherein each waveform defines a field of visibility of a wave having this form.

13. The method according to claim 12, wherein each field of visibility comprises a field in distance and a field in speed of an active track.

14. The method according to claim 12, wherein two active tracks are compatible when they are in the same field of visibility with a probability greater than a predetermined threshold.

15. A target detection radar comprising technical units configured to implement the method according to claim 1.
